(19) United States
(12) Patent Application Publication
(10) Pub. No.: US 2007/0279947 A1
(43) Pub. Date: Dec. 6, 2007

(54) High-Voltage Direct-Current Transmission Device

(75) Inventors: Dennis Brandt, St. Germain South (CA); Mojtaba Mohaddes, Winnipeg (CA)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/631,774

(22) PCT Filed: Jun. 21, 2005
(86) PCT No.: PCT/DE05/01129

§ 371 Date: Jan. 5, 2007

(30) Foreign Application Priority Data
Jul. 5, 2004 (DE) 10 2004 0330578.8

(51) Int. Cl. H02J 3/36; H02M 5/45

(52) U.S. Cl. 363/35; 363/37

(57) ABSTRACT

A device for the transmission of a high-voltage direct current has a supply connection terminal for connecting an alternating current network that supplies energy and a consumer connection terminal for connecting a multi-phase consumer. A rectifier is connected downstream of the supply connection terminal, the rectifier is connected to an inverter by way of a direct-current intermediate circuit that includes a smoothing element. The alternating current side of the inverter is connected to the consumer connection terminal. The rectifier and the inverter include thyristor valves and a control unit drives the thyristor valves of the inverter in accordance with a clock pulse. The device enables power to be supplied to passive consumers such as stand-alone networks. For that purpose, the control unit is connected to a clock pulse generator that produces the clock pulse, the generator having its own energy supply. Capacitive impedances for commutating the current are connected downstream of the inverter in the direction of the power flow, or the multi-phase consumer has a capacitive impedance that is sufficient for the commutation of the current.

The invention relates to an apparatus for high-voltage direct-current transmission having a supply connecting terminal for connection of an alternating-current mains system which feeds energy and having a load connecting terminal for connection of a polyphase load, with the supply connecting terminal being followed by a rectifier which is connected via a direct-current intermediate circuit which has smoothing means to an inverter which is connected on the alternating-current side to the load connecting terminal, with the rectifier and the inverter having thyristor valves and with a control unit triggering the thyristor valves in the inverter as a function of a clock signal.

The invention also relates to a method for high-voltage direct-current transmission in which alternating current from a polyphase alternating-current mains system which feeds energy, is rectified by a rectifier and is transmitted as direct current to an inverter, and the inverter converts the direct current to alternating current in order to supply a polyphase load, with the rectifier and the inverter having thyristor valves, and a control unit triggering the thyristor valves in the inverter as a function of a clock signal.

An apparatus such as this and a method such as this are known, for example from the “Guide for Planning DC Links Terminating AC DC Systems Locations Having Low Short-Circuit Capacities” from the CIGRE Working Group 14.07 and IEEE Working Group 05.15.05, Cigre, Paris from the year 1992. This document discloses high-voltage direct-current transmission systems in which a DC voltage circuit connects power distribution mains systems which carry alternating current to one another. In this case, converter stations are connected to the respective three-phase voltage mains system and are used for rectification or inversion of the current. The converters have power semiconductor valves which are connected to one another in bridge circuits, normally using thyristors. Thyristors have considerably lower power losses than other power semiconductors such as so-called GTOs or IGBTs and, furthermore, can be produced at low cost.

In contrast, thyristors have the disadvantage that they can admittedly be changed by an electrical trigger signal from a reverse-biased state in which any current flow through the thyristors is interrupted to a forward-biased state in which current can flow through the thyristor valves. However, it is not possible to switch off the thyristor valves by means of trigger signals. The thyristor is not changed back to its reverse-biased state until the current which is flowing through the thyristor falls below its holding current. Thyristors are thus considered to be externally-commutated or mains-commutated power semiconductors. In conventional high-voltage direct-current transmission, two converters which are connected via a direct-current circuit are each connected to an alternating-current mains system. In this case, the three-phase voltage of the alternating-current mains system in the case of converters which are being operated as inverters ensures the commutation of the current at the alternating-current-side output of the inverter, thus ensuring that the thyristors which are no longer being triggered are changed from their forward-biased state to their reverse-biased state. According to the previous specialist opinion, high-voltage direct-current transmission systems with self-commutating power semiconductors such as IGBTs should be used for supplying power to so-called island mains systems which do not have their own voltage source and therefore cannot provide any three-phase voltage for the commutation of the current during high-voltage direct-current transmission. However, IGBTs are costly and have high power losses, which likewise result in cost disadvantages in comparison to thyristors during operation.

The object of the invention is thus to provide an apparatus and a method of the type mentioned initially which also allows power to be supplied to so-called island mains systems or other loads which do not have their own voltage source.

According to a first variant, the invention achieves this object in that the control unit is connected to a clock transmitter which produces the clock signal and has its own power supply, with the inverter being followed by capacitive impedances for commutation of the current in the direction of the power flow, or the polyphase load having a capacitive impedance which is sufficient for commutation of the current. In order to be adequate, the capacitive load must be sufficiently large that the converter can be operated so far in the inductive range at the fundamental frequency that is predetermined by the clock transmitter that this results in a sufficiently large turn-off angle in order to maintain the hold-off time of the thyristors.

According to a second variant, the invention achieves this object in that a clock transmitter with its own independent power supply produces the clock signal, and a capacitive impedance which is sufficient for commutation of the current is provided on the alternating-current side of the inverter.

According to the invention, thyristor valves may be used to supply power to island mains systems or to other passive loads. In other words, passive loads without their own commutation voltage can be supplied with power from a feeding composition mains system via a high-voltage direct-current transmission system whose converters have thyristor valves. The voltage which is required for the commutation of the current is provided exclusively by means of capacitive impedances, which follow the inverter in the power flow direction. Additional power semiconductor valves in parallel commutation paths or valves which can be turned off actively are superfluous according to the invention. For example, according to the invention, it is thus possible to connect the individual phases to one another via capacitors at the alternating-current-side output of the inverter. The triggering time, for example, of the first phases, is dependent only on the clock signal produced by the independent clock transmitter. In this case, not only the capacitance which is located between the current-carrying phases, but also the two capacitances which are connected via the phase which is not carrying current are charged. These provide the necessary commutation voltage after triggering of the next thyristor. This leads to a current rise in the newly triggered valve, and to the current in the valve which is intended to be turned off falling below the holding current. This thyristor valve is thus once again changed to its reversed-biased position. According to the invention, the inverter is not regulated. The thyristor valves are triggered only on the basis of the phase of the clock signal, which is independent of the three-phase voltage at the inverter. The invention thus overcomes a long-lasting prejudice, specifically that thyristor valves are unsuitable for supplying passive loads in high-voltage direct-current transmission.

There is no need for the capacitive impedances to be formed by capacitors between the phases of the load. The capacitive impedances can be provided in any desired manner. In addition the load itself may provide a capacitive impedance by means of which, according to the present invention, it is likewise possible for the current to be commutated. The capacitive impedance of the load may also be in the form of an impedance which is produced by specific capacitor banks.

In principle, any expedient clock transmitter may be used for the purposes of the invention. However, it is advantageous for the clock transmitter to be a free-running oscillator. Free-running oscillators are very well known to those skilled in the art, and they do not, therefore, need to be described at this point.

The capacitive impedances are expediently provided by at least one capacitor bank. The capacitor banks allow the apparatus according to the invention to be designed essentially independently of the load, since the capacitor banks make it possible to ensure that the necessary capacitances for the commutation of the current are provided in all cases. The capacitances of the capacitors should be designed appropriately for this purpose.

The capacitor banks are expediently connected between the inverter and the supply connecting terminal, connected in parallel with the load. This arrangement of the capacitor banks close to the inverter results in the greatest capacitive effect. This leads to a faster commutation and thus to shorter overlap angles during inversion.

The polyphase load is expediently an island mains system which does not have its own voltage source. Island mains systems can be found, for example, on high-seas platforms which are used, for example, for oil drilling.

However, in contrast to this, the load may also be a simple electric motor and/or may be in the form of one or a number of other electrical machines.

The direct-current intermediate circuit expediently has direct-current conductors with a length of more than 30 kilometers. High-voltage direct-current transmission systems such as these are preferably used for supplying power to remote island mains systems which are a long distance away from the mixed mains system.

In contrast to this, rectifiers and inverters are installed directly adjacent to one another (back to back) thus forming a so-called short coupling. Short couplings such as these are used, for example, for coupling of alternating-current mains systems with a different fundamental frequency, phase angle, use of star points or the like. An arrangement such as this is also advantageous for drive purposes.

The AC voltage which occurs on the alternating-current side of the inverter is advantageously regulated only by means of the rectifier. As has already been stated, no regulation is provided, according to the invention, for the inverter. The three-phase voltage which is dropped across the alternating-current side of the inverter is dependent on the impedances there and also on the magnitude of the alternating current. The alternating current and thus the AC voltage, may, however, be governed by the direct current and thus by the rectifier regulation.

According to one expedient further development relating to this, the AC voltage which is dropped on the alternating-current side of the inverter is measured with an AC measurement voltage being obtained, the AC measurement voltage is compared with a reference voltage, a reference direct-current signal is then produced as a function of this comparison, the current in the direct-current intermediate circuit is measured with a direct-current measurement signal being obtained, the direct-current measurement signal is compared with the reference direct-current signal, and the thyristor valves in the rectifier are triggered as a function of this comparison and such that the desired AC measurement voltage is produced.

Further expedient refinements and advantages of the invention are the subject matter of the following description of exemplary embodiments of the invention, with reference to the figures of the drawing, in which components having the same effect are provided with the same reference symbols, and in which

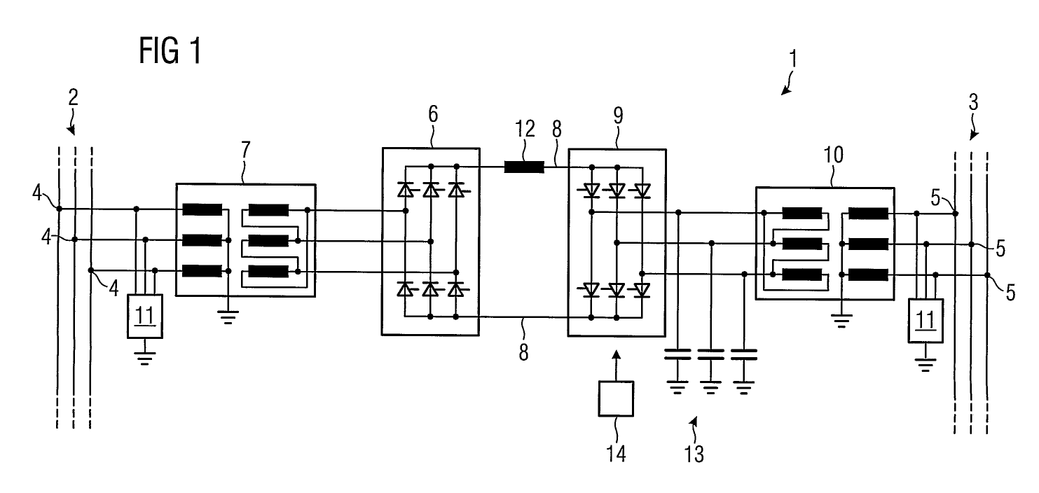

FIG. 1 shows one exemplary embodiment of an apparatus according to the invention,

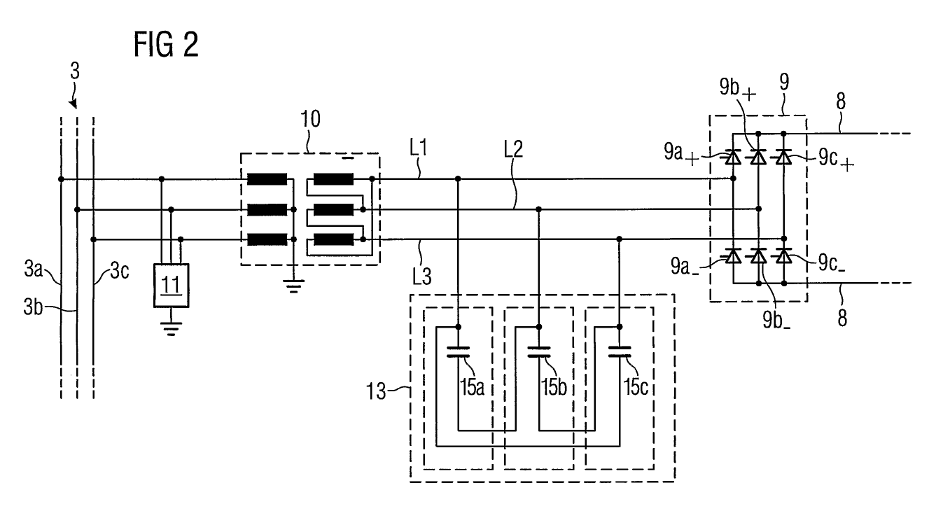

FIG. 2 shows the inverter side of an apparatus as shown in FIG. 1, and

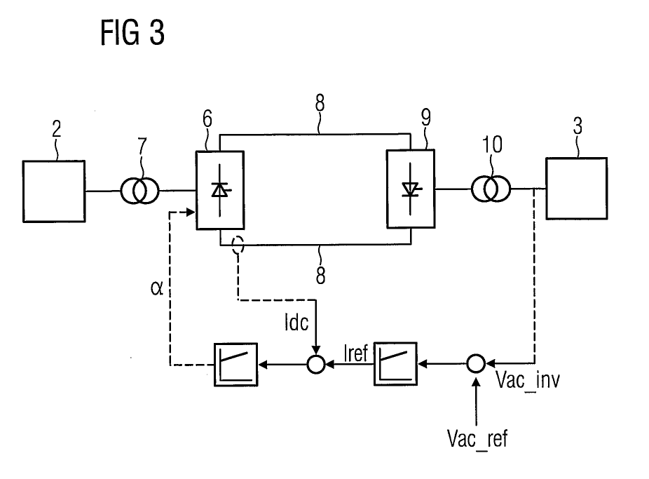

FIG. 3 shows a schematic illustration in order to show one exemplary embodiment of the method according to the invention.

FIG. 1 shows one exemplary embodiment of the apparatus 1 according to the invention which is designed to transmit energy from a feeding alternating-current mains system 2 to an island mains system 3, which essentially does not have its own voltage source. In this case, the apparatus 1 has a supply connecting terminal 4 for connection of the feeding alternating-current mains system 2 as well as a connecting terminal 5 for connection of the load, which in this case is in the form of an island mains system 3. The supply connecting terminal 4 is followed by a rectifier 6, with a transformer 7 being arranged between the supply connecting terminal 4 and the rectifier 6. The rectifier 6 is connected via a direct-current intermediate circuit 8 to an inverter 9, which is followed by a further transformer 10 and the load connecting terminal 5. Furthermore, filter banks 11 are provided, which are known per se and are tuned to harmonics of the respective rated frequency of the three-phase voltage in the alternating-current mains systems 2, 3. Disturbing harmonics such as these can occur during the rectification and inversion. The harmonics are effectively suppressed by the filters connected in parallel with the respective mains system. An inductance 12 is provided in the direct-current intermediate circuit 8 in order to smooth the direct current. Capacitors 13 are arranged on the alternating-current side of the inverter 9, connected in parallel with the island mains system 3, and have a capacitive impedance which is sufficient for commutation of the current. A control device 14 is provided in order to control the inverter 9, and its method of operation will be described in more detail in the following text.

FIG. 2 shows a more detailed illustration of the inverter 9 from which it can be seen, in particular, that the island mains system 3 comprises three phases 3a, 3b, 3c, which are connected via the transformer 10 to the inverter 9. The inverter 9 essentially comprises two commutation groups with the thyristor valves 9a₊, 9b₊, 9c₊ and 9a₋, 9b₋, 9c₋, which are connected to one another in a six-pulse bridge circuit. The phases of the island mains system 3 have associated connecting conductors L1, L2 and L3. The figure also shows that the capacitor bank 13 also comprises three capacitors (15a, 15b, 15c) which are connected to the connecting conductors L1, L2 and L3 in a delta circuit. The start commences, for example by triggering of the thyristors 9a₊ and 9c₋. The direct current that is produced by the rectifier charges both the capacitor 15c which is connected directly to the current-carrying phases (L1 and L3), and the two capacitors 15a and 15b which are connected via the phase L2 in which no current is flowing. When the next thyristor branch (9b₊) is triggered, the voltage across the capacitor 15a ensures the necessary commutation voltage, so that the current is commutated from the thyristor 9a₊ to the thyristor 9b₊. This results in the thyristor 9a₊ changing to its reverse-biased state. The other commutation processes take place in the same manner with a time offset.

FIG. 3 shows a schematic illustration of the method according to the invention. This shows, in particular, a supply mains system 2 as well as an island mains system 3, which are connected to one another via the already-described apparatus 1. As has already been explained, the triggering of the thyristors in the inverter 9 is dependent only on the independently produced clock signal from the clock transmitter, which will not be described with reference to FIG. 3. No regulation is provided for the inverter. The AC measurement voltage of the island mains system 3 is measured, for example with the aid of a voltage divider or converter in order to set the three-phase voltages in the island mains system 3. The measured AC measurement voltage Vac_inv is then compared with a configured nominal or reference voltage Vac_ref, with a nominal current value or a reference direct-current signal I_{ref} being produced with the aid of internal logic in the control unit. The impedance of the island mains system 3 is used as a parameter for the said internal logic, which uses it to calculate the direct-current reference signal. The reference direct-current signal is compared with the measured direct current Idc, and the triggering of the rectifier 6 is varied by variation of the trigger angle α as a function of the comparison such that the measured AC voltage Vac_inv corresponds to the reference value Vac_ref.

1-9. (canceled)

10. An apparatus for high-voltage direct-current transmission, comprising:
a supply connecting terminal for connection of an alternating-current network for supplying energy;
a load connecting terminal for connection of a polyphase consumer;
a rectifier connected to said supply connecting terminal, an inverter having alternating-current side connected to said load connecting terminal, and a direct-current intermediate circuit with a smoothing means connecting said inverter to said rectifier;
said rectifier and said inverter having thyristor valves;
a control unit connected to said thyristor valves in said inverter, a clock signal generator having a separate power supply and producing a clock signal for said control unit, and said control unit driving said thyristor valves in said inverter in accordance with the clock signal; and
wherein capacitive impedances for commutation of a current are connected to follow said inverter in a direction of a power flow, or the polyphase consumer is provided with a capacitive impedance sufficient for commutation of the current.

11. The apparatus according to claim 10, wherein said clock generator is a free-running oscillator.

12. The apparatus according to claim 10, which comprises at least one capacitor bank defining said capacitive impedances.

13. The apparatus according to claim 12, wherein each said capacitor bank connected between said inverter and said load connecting terminal is connected in parallel with the consumer.

14. The apparatus according to claim 10, wherein said polyphase consumer is an island mains system substantially without a separate voltage source.

15. The apparatus according to claim 10, wherein said direct-current intermediate circuit includes direct-current conductors with a length of more than 30 km.

16. A method of high-voltage direct-current transmission, which comprises:
rectifying an alternating current from a polyphase alternating-current mains system supplying energy with a rectifier to form a direct current;
transmitting the direct current to an inverter;
converting the direct current with the inverter to an alternating current and supplying a polyphase consumer with the alternating current, wherein the rectifier and the inverter have thyristor valves; and
generating a clock signal with a clock generator having a separate power supply;
driving the thyristor valves of the inverter with a control unit in accordance with the clock signal; and
commutating an alternating-current output by the inverter with a capacitive impedance sufficient for commutation.

17. The method according to claim 16, which comprises regulating an AC voltage occurring on the alternating-current side of the inverter substantially exclusively by way of the rectifier.

18. The method according to claim 17, which comprises
measuring the AC voltage occurring on the alternating-current side of the inverter and obtaining an AC measurement voltage, comparing the AC measurement voltage with a reference voltage and producing a reference direct-current signal in dependence on a result of the comparing step;
measuring a direct-current intermediate circuit and obtaining a direct-current measurement signal, comparing the direct-current measurement signal with a reference direct-current signal to form a comparison result; and
driving the thyristor valves in the rectifier as a function of the comparison result in order to produce a desired AC measurement voltage.
